(19) United States
(12) Patent Application Publication
(10) Pub. No.: US 2012/0263161 A1
(43) Pub. Date: Oct. 18, 2012

(54) MULTIPLE SATELLITE MODEM SYSTEM USING A SINGLE ANTENNA

(75) Inventors: Stephen Harke, Calgary (CA); Daniel Bobyn, Calgary (CA)

(73) Assignee: AEROMECHANICAL SERVICES LTD., Calgary, AB (CA)

(21) Appl. No.: 13/509,334

(22) PCT Filed: Dec. 17, 2010
(86) PCT No.: PCT/CA10/02018

§ 371 Date: Jul. 4, 2012

Related U.S. Application Data
(60) Provisional application No. 61/289,121, filed on Dec. 22, 2009.

(51) Int. Cl. H04W 4/00

(52) U.S. Cl. 370/339

(57) ABSTRACT

A system having multiple modems using a single antenna includes a first modem connected to a first communication system, and a second modem connected to a second communication system; a first transmission path operatively connected to the first modem, a second transmission path operatively connected to the second modem, a third transmission path operatively connected to both the first and second modems and including a signal combiner; a switch operatively connected to the single antenna, and operative to select the first, second or third transmission paths, or an incoming signal path; a first transmission detector connected to the first transmission path, and a second transmission detector connected to the second transmission path. A controller is responsive to the first and second transmission detectors and operates switches to route transmissions and incoming signals in accordance with control logic.

### FIELD OF INVENTION

The present invention relates to a data transmission system having multiple modems and a mixer module to route incoming and outgoing signals through a single antenna.

### BACKGROUND OF THE INVENTION

Data transmissions systems for wirelessly transmitting data, such as through a satellite communication network, are common. Multi-link modem systems are also common. Typically, each modem in a multi-link system is required to have its own antenna. However, in some cases it is desirable to use a single antenna connected to more than one modem, or one type of modem. Depending on the type of data to be used, the most effective type of data transmission can be selected and the modem using that type of transmission used to transmit the data. However, rather than using a separate antenna for each of the modems (i.e. two antennas for a system using dual modems), it may be preferred to combine data transmissions to a single antenna. This is desirable in instances such as when the data transmission system is used in an aircraft. An antenna requires a breach of the aircraft outer skin, therefore minimizing the number of antennas is desirable. As well, the weight of the cables running to the antenna should also be minimized in an aircraft environment.

However, using a single antenna with two separate modems can result in problems occurring when the modems are both transmitting or receiving signals at the same time. While it is also common for the signals to be passively combined into one signal to be transmitted over the antenna and the signal split for incoming signals received on the antenna, the associated losses between the modems and the antenna when the signal is passively combined are undesirable.

### SUMMARY OF THE INVENTION

The detailed description set forth below in connection with the appended drawings is intended as a description of various embodiments of the present invention and is not intended to represent the only embodiments contemplated by the inventor. The detailed description includes specific details for the purpose of providing a comprehensive understanding of the present invention. However, it will be apparent to those skilled in the art that the present invention may be practiced without these specific details.

In one aspect, the invention comprises a transceiver system comprising a single antenna, said system comprising:
(a) at least two modems comprising a first modem connected to a first communication system, and a second modem connected to a second communication system;
(b) a first transmission path operatively connected to the first modem and comprising a first switch, a second transmission path operatively connected to the second modem and comprising a second switch, a third transmission path operatively connected to both the first and second modems and comprising a signal combiner;
(c) a third switch operatively connected to the single antenna, and operative to select the first, second or third transmission paths, or an incoming signal path;
(d) a first transmission detector connected to the first transmission path, and a second transmission detector connected to the second transmission path;
(e) a controller responsive to the first and second transmission detectors and operatively connected to the first, second and third switches.

In one embodiment, the system comprises a first amplifier associated with the first modem and the first and third transmission paths, and a second amplifier associated with the second modem and the second and third transmission paths, wherein both the first and second amplifiers are upstream from the signal combiner.

In another aspect, the invention may comprise a method of utilizing multiple modems with a single antenna, said method comprising:
(a) operating a first modem connected to a first communication system, and a second modem connected to a second communication system;
(b) providing a first transmission path operatively connected to the first modem and comprising a first switch, a second transmission path operatively connected to the second modem and comprising a second switch, a third transmission path operatively connected to both the first and second modems and comprising a signal combiner;
(c) providing a third switch operatively connected to the single antenna, and operative to select the first, second or third transmission paths, or an incoming signal path;
(d) providing a first transmission detector connected to the first transmission path, and a second transmission detector connected to the second transmission path;
(e) controlling the first, second and third switches to route signals from the first modem through the first transmission path when the second modem is not transmitting, or to route signals from the second modem through the second transmission path when the first modem is not transmitting, or to route simultaneous signals from the first and second modems through the third transmission path.

### BRIEF DESCRIPTION OF THE DRAWINGS

Referring to the drawings wherein like reference numerals indicate similar parts throughout the several views, several aspects of the present invention are illustrated by way of example, and not by way of limitation, in detail in the figures, wherein:

FIG. 1 is a schematic illustration of one embodiment of a data transmission system using dual modems to transmit data through a single antenna;

FIG. 2 is a block diagram of one embodiment of a mixer module to route transmissions to and from dual modems and single antenna;

FIG. 3 is a block diagram of an another embodiment of a mixer module;

FIG. 4 is a block diagram of an alternative embodiment of a mixer module;

FIG. 5 is a detailed schematic diagram of the LBT and SBD transmission detection and switching circuits of the embodiment of FIG. 4.

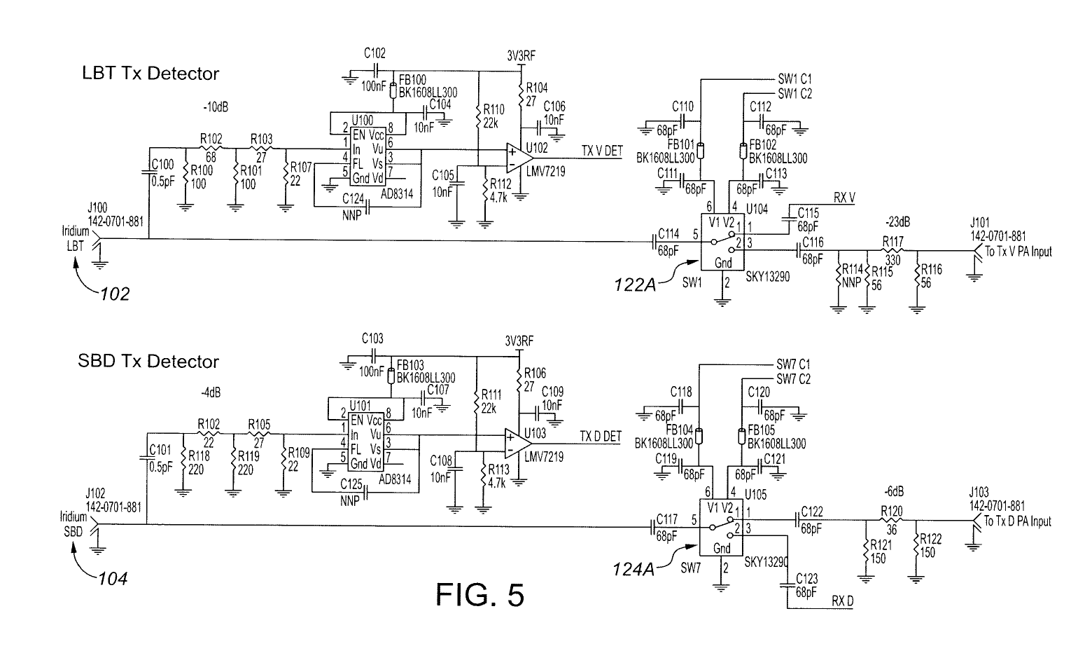

FIG. 6 is a detailed schematic diagram of the transmission combining and switching circuits of the embodiment of FIG. 4.

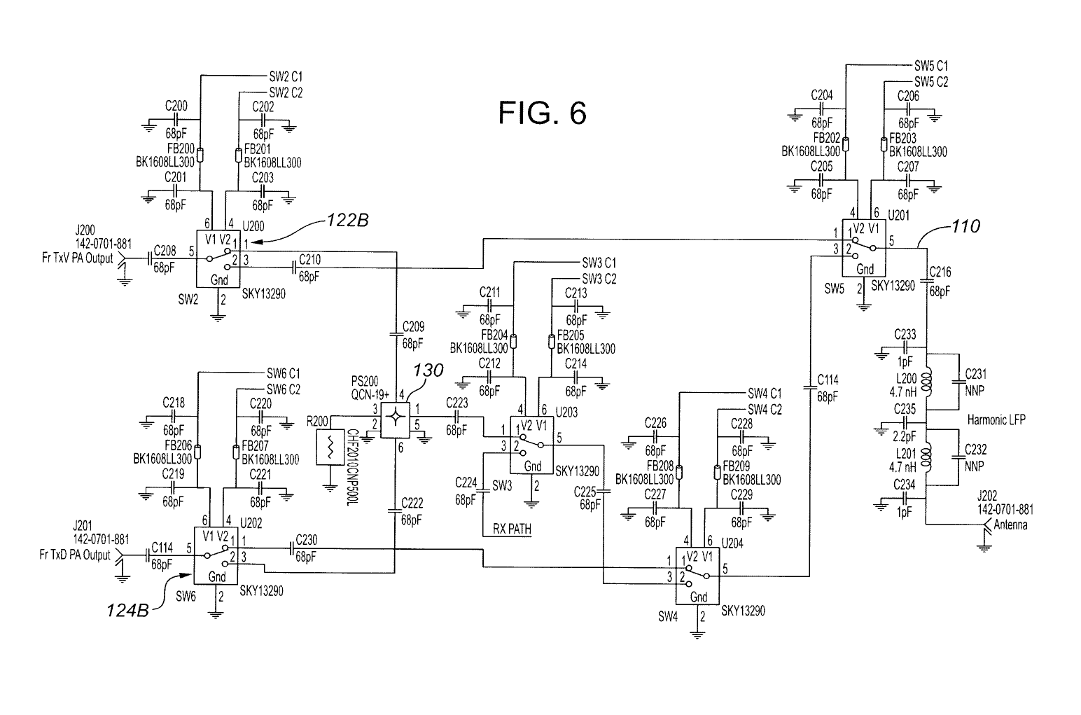

FIG. 7 is a detailed schematic diagram of the data reception, amplification and switching circuits of the embodiment of FIG. 4.

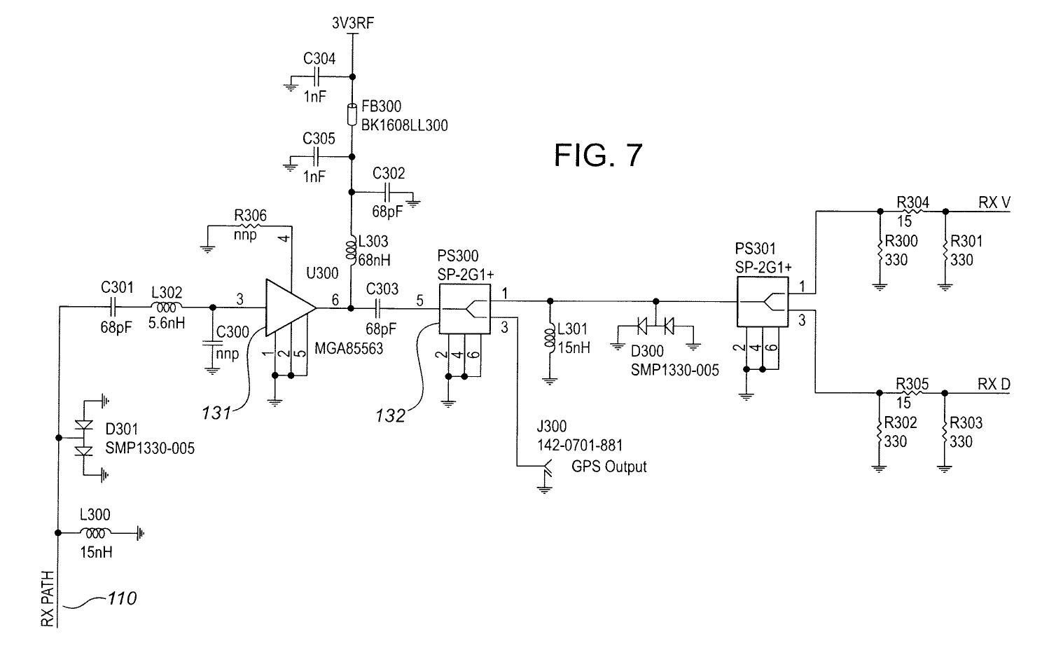

FIG. 8A is a detailed schematic of the control logic system of the embodiment of FIG. 4.

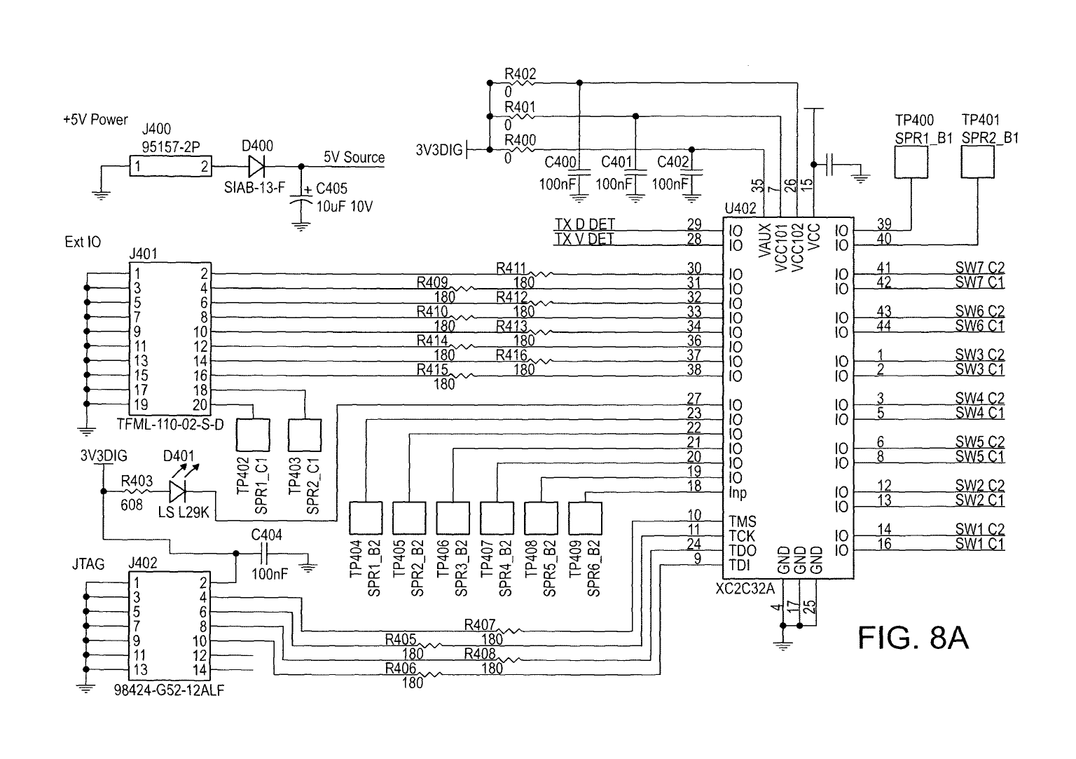

FIG. 8B is a detailed schematic of the 5V power supply of the embodiment of FIG. 4.

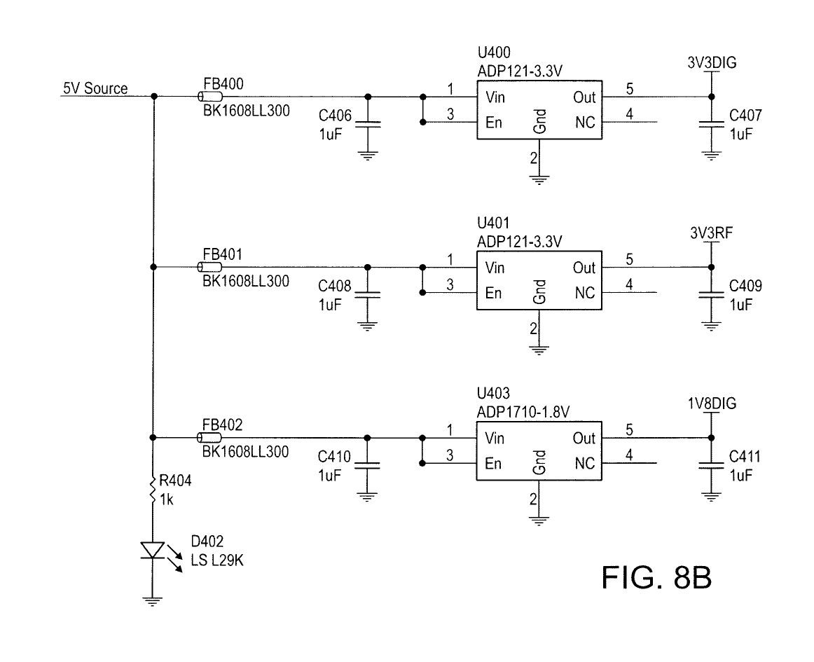

### DESCRIPTION OF VARIOUS EMBODIMENTS

The detailed description set forth below in connection with the appended drawings is intended as a description of various embodiments of the present invention and is not intended to represent the only embodiments contemplated by the inventor. The detailed description includes specific details for the purpose of providing a comprehensive understanding of the present invention. However, it will be apparent to those skilled in the art that the present invention may be practiced without these specific details.

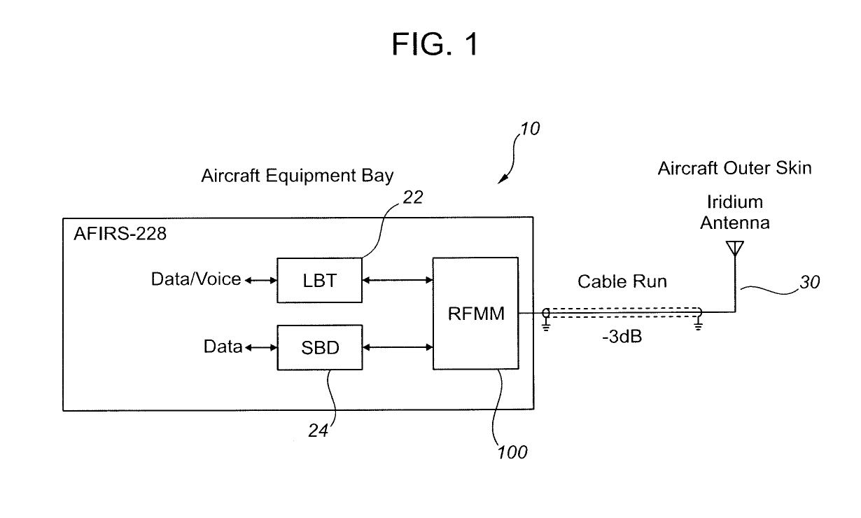

FIG. 1 is a schematic illustration of a data transmission system (10) that uses dual modems to transmit and receive data using a single antenna (30). The system (10) can have a first satellite modem (22) and a second satellite modem (24). A mixer module (100) is used to route and combine signals from the first and second satellite modem (22, 24) to a single RF antenna connector to a single antenna (30). In this manner, a dual modem configuration can be used with a single antenna (30). This technique can be applied in a similar fashion with more than two modems being connected to a single antenna. In one embodiment, the system comprises three, or four modems.

As used herein, a modem is a device which modulates a carrier signal to encode information for transmittal, and which also demodulates a carrier signal to decode received information. A satellite modem is a modem used to establish data transfers using a communications satellite. An input stream is transformed into a radio signal for transmission, and incoming radio signals are transformed into streams in the opposite direction.

The first satellite modem (22) and the second satellite modem (24) can independently generate signals, and then the mixer module (100) can be used to route these signals to the single antenna (30), to be transmitted to a satellite communication system. Additionally, signals from a satellite system, for either or both of the first satellite modem (22) and the second satellite modem (24), can be received using the single antenna (30) and then routed to the proper satellite modem (22, 24), using the mixer module (100).

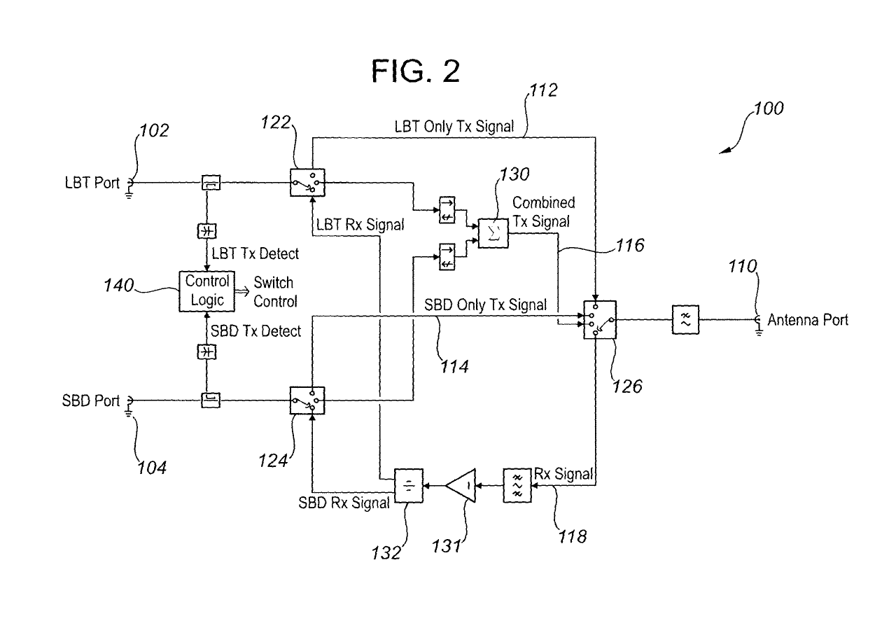

FIG. 2 illustrates a block diagram of one embodiment of the mixer module (100) which is operative to receive signals from the two modems (22, 24) and route them to the antenna port (110), as well as to receive signals from a satellite network and route these signals to the proper modem (22, 24). If the mixer module (100) detects that only one of the modems (22, 24) is transmitting data, it can route these signals to the single antenna (30). If the mixer module (100) detects that both of the modems (22, 24) are transmitting simultaneously, then it can combine the signals from the two modems (22, 24) and route them to the single antenna (30).

The mixer module (100) comprises a first modem port (102) for receiving signals transmitted from the first modem (22) and a second modem port (104) that can receive signals transmitted from the second modem (24). An antenna port (110) connects the mixer module (100) to the single antenna (30). Signals received by the antenna (30) go through the antenna port (110), and are routed by the mixer module (100) to the first modem port (102) and the second modem port (104) through paths marked Rx Signal.

The mixer module (100) comprises a first signal path (112) connecting to the first modem (22) via the first modem port (102), a second signal path (114) connecting to the second modem (24) via a second modem port (104), a combined signal path (116) and an incoming signal path (118). A first switch (122) switches the connection between the first modem port (102) the incoming signal path (118), the combined signal path (116), or the first signal path (112). Similarly, the second switch (124) switches the connection between the second modem port (104), and the incoming signal path (118), the combined signal path (116), or the second signal path (114).

The signal paths (112, 114, 116) lead to an antenna switch (126), which leads to the antenna port (110). The antenna switch chooses between the incoming signal path (118) and the first, second and combined signal paths (112, 114, 116). All switches can be defaulted to an incoming signal mode.

The second signal path (114) can be used to route signals from the second modem port (104) to the antenna port (110) when the second modem (24) is transmitting, but the first modem (22) is not. The second signal path (114) can be directly connected between a second switch (124) and the antenna switch (126). From the antenna switch (126), the signals can be routed to the antenna port (110) and subsequently to the single antenna (30).

The combined signal path (116) can be used to route signals through the mixer module (100) when both modems (22, 24) are transmitting at the same time. The combined signal path (116) can route outgoing signals from both the first modem (22) and the second modem (24) together through a signal combiner (130) to combine the signals into one combined signal before routing the combined signal to the antenna switch (126) and then to the antenna port (110) to be transmitted using the single antenna (30).

In this manner, when a single modem is transmitting but not both, the signals are routed through either the first signal path (112) or the second signal path (114) and only suffer minimal loss of signal strength. Only when both the modems (22, 24) are transmitting at the same time will the signals be routed through the combined signal path (116) and the signal combiner (130).

The incoming signal path (118) can be used to route signals received using the single antenna (30) from a satellite network to both the first and second modems (22, 24). The signals can enter the mixer module (100) from the single antenna (30) through the antenna port (110) and be routed through the incoming signal path (118) to the first modem port (102) and the second modem port (104). The incoming signal path (118) can include any desired filters, an amplifier (131) to amplify the incoming signal and a signal divider (132) to divide the signal received using the single antenna (30) for the first modem (22) and the second modem (24). The amplifier (131) can amplify the received signals to overcome power splitter losses in the signal divider (132) before reaching the modems (22, 24) to preserve the modem receive sensitivity.

One or more GPS receiver taps (not shown) can also be taken off of the signal divider (132) to provide a GPS receiver connection to the single antenna (30).

The first switch (122) can be used to route signals to and from the first modem port (102). The first switch (122) can be used to route signals from the first modem port (102) through the first signal path (112) if the first modem (22) only is transmitting information and through the combined signal path (116) if both modems (22, 24) are transmitting. The first switch (122) can also route signals from the incoming signal path (118) to the first satellite modem port (102) when signals are being received through the single antenna (30) for the modems (22, 24).

The second switch (124) can be used to route outgoing signals from the second satellite modem input (104) through either the second signal path (114), if the second modem (24) only is transmitting information, and through the combined signal path (116) if both of the modems (22, 24) are transmitting information. The second switch (124) can also be used to route signals being received from the single antenna (30) through the antenna port (110) and passing through the incoming signal path (118) to the second modem port (104).

A control logic circuit (140) can be used to control the various switches (122, 124, 126) and route the signals through the first signal path (112), the second signal path (114), the combined signal path (116) and the incoming signal path (118), as desired. The control logic circuit (140) is operably connected to the first satellite modem port (102) and the second satellite modem port (104) to determine when the first modem (22) and/or the second modem (24) are transmitting. When the control logic circuit (140) detects that signals are being transmitted by the first modem (22) through the first satellite modem port (102) and the second modem (24) is not transmitting any signals, the control logic circuit (140) can control the first switch (122) and the antenna switch (126) to route the signals from the first modem (22) through the first signal path (112).

When the control logic circuit (140) detects that the second modem (24) is transmitting signals but the first modem (22) is not transmitting any signals, the control logic circuit (140) can control the second switch (124) and the antenna switch (126) to route the signals through the second signal path (114).

When the control logic circuit (140) detects that both the first modem (22) and the second modem (24) are transmitting signals simultaneously, the control logic circuit (140) can control the first switch (122), the second switch (124) and the antenna switch (126) to route the signals through the combined signal path (116) where the signals can be combined into a combined signal before being routed to the antenna port (110) through the antenna switch (126).

In one embodiment, the mixer module (100) and the control logic circuit (140) can have a default state wherein the switches (122, 124 and 126) are set so that the mixer module (100) is configured in the incoming signal path (118) unless the control logic circuit (140) detects that either the first modem (22) or the second modem (24) is transmitting. In this manner, if any signals are received by the single antenna (30), the mixer module (100) will already have the switches (122, 124 and 126) set to route signals through the incoming signal path (118) to either or both the first modem (22) and the second modem (24). If the control logic circuit (140) detects that either the first modem (22) or the second modem (24) is transmitting signals, the control logic circuit (140) can operate the necessary switches (122, 124 and 126) to connect the first signal path (112), the second signal path (114) or the combined signal path (116).

A person skilled in the art will appreciate that various other components that are not specifically shown in the figures, such as amplifiers, filters, etc. as are desirable or required for specific implementations.

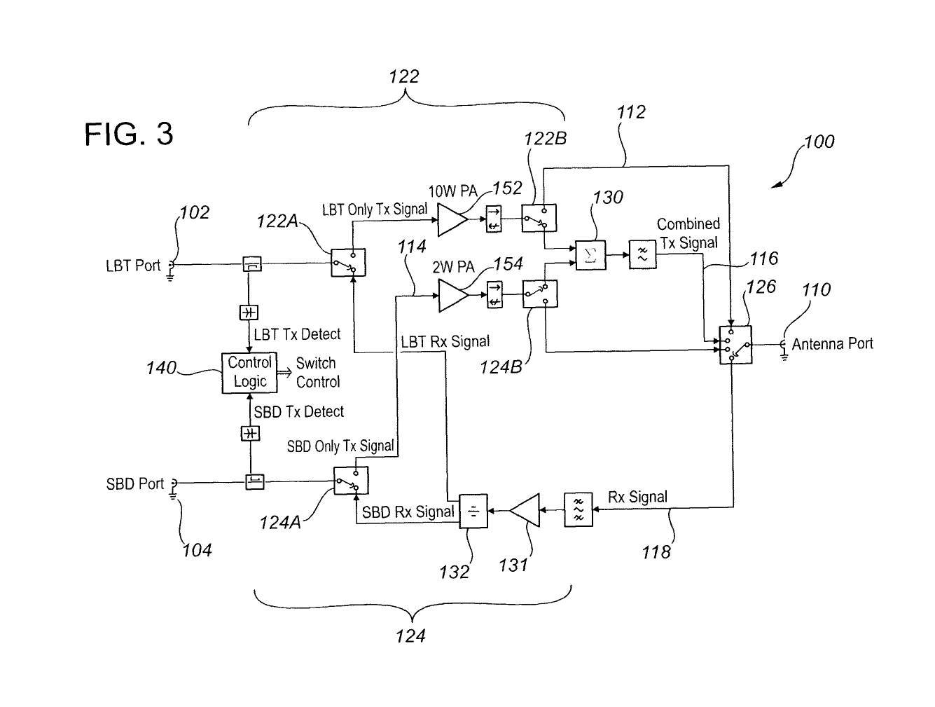

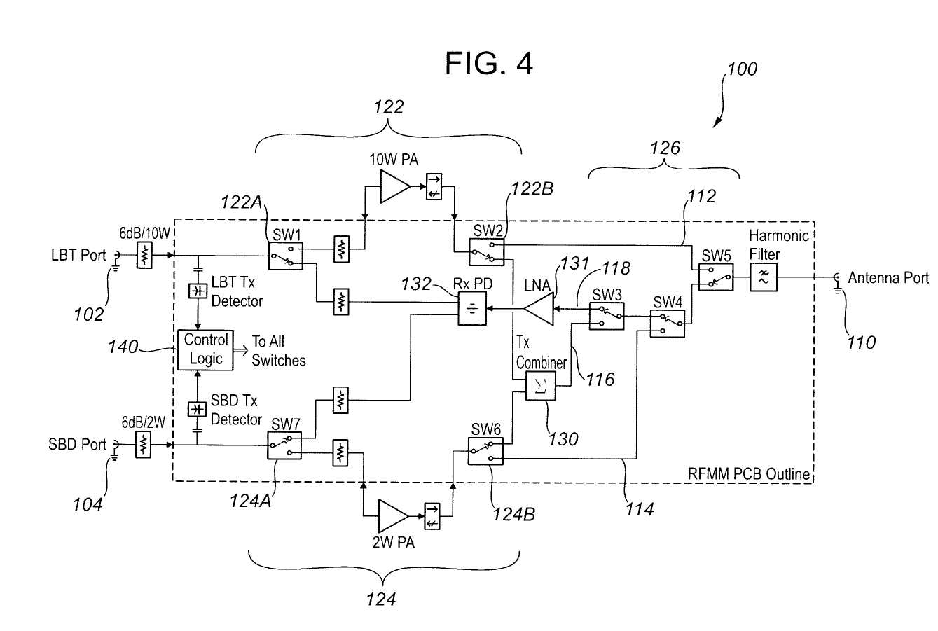

FIG. 2 illustrates one embodiment of the mixer module (100) wherein the first switch (122) and the second switch (124) both have three possible outputs. However, the mixer module (100) can be implemented in various different ways. FIG. 3 illustrates another embodiment of the mixer module (100) wherein the first switch (122) and the second switch (124) are each implemented with two separate switches, the first switch (122) can be implemented with a first stage switch (122A) and a second stage switch (122B). The second switch (124) can also be implemented using a first stage switch (124A) and a second stage switch (124B). This configuration includes amplifiers (152, 154). FIG. 4 illustrates a further more detailed implementation of the mixer module (100) showing the use of attenuators, filters, and the like.

In one embodiment, the amplifiers (152, 154) are upstream of the signal combiner (130). In one embodiment, the amplifiers selectively amplify the transmission signal when the transmission detectors detect signals from both the first and second modems. Thus amplification only occurs when required to overcome signal loss by combination, and occurs prior to signal combination. Attempts to amplify the combined signal, downstream from the signal combiner (130), would result in unacceptable out-of-band emissions.

In one embodiment, the first modem (22) may be a satellite modem configured to operate using a service configured to send or receive large amounts of data, such as, for example, the Iridium™ LBT. The LBT (L-band transceiver) is designed to send relatively large amounts of data, such as voice data, a 2400 baud RUDICS data connection, or SBD (short burst data) packets ranging from one byte to 1960 bytes in size. A user can, in real time, select which of the services the LBT transceiver utilizes.

The second modem (24) can be a satellite modem configured to send and receive smaller amounts of data, such as for example, the Iridium™ SBD service. The SBD (short burst data) service is designed for applications that can send and receive short data messages ranging from one byte to 270 bytes (receive) or one byte to 340 bytes (send) in size. The SBD service can be used to transmit and receive short, repetitive data packets (e.g. one data message approximately every 5 minutes).

Other embodiments may implement or be configured for use with other satellite communication systems or services, the nature of which is not intended to limit the claimed invention, unless explicitly referenced in the claims.

If the first modem (22) is a satellite modem configured to use the LBT services and the second modem (24) is a satellite modem configured to use the SBD service, the frequency of the typical transmissions using these two formats can be used to advantage. The first modem (22) and the LBT services can be used for voice messages and longer transmissions of data which can occur for a relatively long periods of time, but occur relatively infrequently.

In one embodiment, the communication systems for both the first and second modems operate on a time-division multiplexed basis, which will assist in minimizing collisions in transmitting and receiving from both modems. Both the Iridium™ LBT and the SBD services utilize Time Division Multiple Access (TDMA) multiplexing.

With the data transmission system (10) set up to use the first modem (22) for longer more infrequent data transmission, such as voice data, and the second modem (24) for smaller more frequent data transfers, when an LBT message is being transmitted from the first modem (22), there may be a high probability that an SBD message from the second modem (24) will occur at the same time. Because of the TDMA frame structure used by the LBT services, the probability that the SBD message will occur in the same time slot as the LBT message is low, on the assumption that the SBD messages using the second modem (24) and the LBT messages using the first modem (22) are not correlated, and that there are four equally likely TDMA time slots in which the LBT messages and SBD messages may occur, the following can be approximated. Additionally, because of the very short duration of messages sent using the SBD service, relative to messages typically sent using the LBT service, when a collision does occurs, it will only attenuate the LBT message for a short period of time (i.e. the length of the SBD message), and then only by the loss of the signal combiner (130).

In regards to SBD messages transmitted by the second modem (24), the SBD messages can be sent frequently compared with the LBT messages from the first modem (22), however, the probability that an infrequently sent LBT message from the first modem (22) will occur at the same time as an SBD message from the second modem (24) is relatively low. Additionally, even if the first modem (22) and the second modem (24) simultaneously transmit a LBT message and a SBD message, respectively, the TDMA frame structure will further reduce the collision rate and even if a collision does occur, the SBD message is only attenuated by the loss of the signal combiner (130).

For example, if the data transmission system (10) is used on an aircraft to transmit data, the first modem (22) using the LBT service can be used to transmit continuous voice messages. These continuous voice messages will typically be relatively long, giving the operator of the aircraft time to discuss various things with the ground control, etc. For example, the average continuous conversation voice message for an aircraft operator using the data transmission system (10) may be an average of four minutes in duration. The conversations will not occur constantly, rather a estimate for the number of these conversation voice messages using the first modem (22) may be fifty of these voice messages occurring per month or approximately six hundred of these calls made using the data transmission system (10) and the first modem (22) per year). With an average aircraft typically having 2000 flight hours per year, the result of these numbers is that approximately a single four minute continuous conversation voice message is made every 200 flight minutes.

Using the same example, if the second modem (24) uses the SBD service, a SBD data message consisting of 100 bytes of data can be transmitted every five (5) minutes. At an average data throughput of 1.2 kbps, a SBD message of 100 bytes will take approximately 667 milliseconds to send. This equates to one 667 millisecond message every five (5) minutes.

The impact of an SBD data message from the second modem (24) colliding with an in process LBT message from the first modem (22) can be evaluated using the assumptions about the length and timing of messages above. With an LBT message transmitted using the first modem (22) that is approximately four minutes long, the probability that an SBD data message will be transmitted by the second modem (24) during the LBT message is 80%. With the TDMA format used by the first modem (22) and the second modem (24) and there being four possible time slots, the probability that the SBD data message transmitted by the second modem (24) will occur during the same time TDMA time slot as the LBT message being transmitted by the first modem (22), reduces the likelihood to 20%. It is only during this simultaneous occurrence of a LBT message from the first modem (22) and a SBD data message from the second modem (24) occurring in the same TDMA time slot, that the signals will be routed by the mixer module (100) through the combined signal path (116) and suffer a momentary power reduction from the signal combiner (130). This moment reduction in power of the signal will be limited to the length of time for the SBD data message (approximately 667 milliseconds based on the assumptions above). Therefore, on average, only one in every five LBT message transmissions by the first modem (22) will have a SBD data message transmitted by the second modem (24) interrupting it.

However, because of the briefness of the SBD data message in relation to the LBT message, the loss of power in the signals as they pass through the signal combiner (130) in the combined signal path (116), should easily be absorbed by the system fade margin. As well, a voice message transmission may suffer some loss without substantially impacting the integrity of the message.

The impact of an LBT message from the first modem (22) colliding with an SBD data message transmitted by the second modem (24) can also be evaluated using the assumptions for the example. Over the two hundred minute period in which only a single LBT message from the first modem (22) will likely occur, forty SBD messages will likely occur (based on the above assumptions). The probability that a LBT message from the first modem (22) will occur and overlap with any of the SBD data messages being transmitted from the second modem (24) is approximately 80%. Therefore, the probability than any single SBD data message transmitted by the second modem (24) will be transmitting when an LBT message is also being sent or received by the first modem (22) is 2%. As outlined above, when taking in the TDMA frame structure used by the LBT service and the SBD service, the probability that a SBD data message will be routed through the combined signal path (116) with a portion of an LBT message and incur power loss from the signal combiner (130) is 0.5%. Therefore, on average using the above assumptions, one out of every two hundred SBD messages transmitted by the second modem (24) will have a reduction in signal amplitude which should easily be absorbed by the system fade margin.

In one example, the mixer module (100) may have the following approximate signal losses and gains. The incoming signal path (118) may have a noise figure degradation of 1.0 dB but a gain (from the amplifier 131) of 3 dB. The first signal path (112) and the second signal path (114) may have a power loss of 1.2 dB each, while the combined signal path (116) may have a power loss of approximately 5.1 dB. The time for the control logic circuit (140) to detect signals from the first modem (22) and/or the second modem (24) and set the switches (122, 124 and 126) for these detected signals may be 1 μSec. Therefore, the mixer module (100) will have a signal loss of 1.2 dB when signals are being routed through either the first signal path (112) or the second signal path (114). When the mixer module (100) is routing signals from both the first modem (22) and the second modem (24), through the combined signal path (116) the signal path has an excess loss of 5.1 dB minus the 1.2 dB, or 3.9 dB.

Using the above examples, in the infrequent event that a SBD data message from the second modem (24) collides with an LBT message from the first modem (22), the signal loss over the combined signal path (116) is only 3.9 dB and this loss only occurs for the 667 milliseconds needed to transmit the SBD data message. Using an average LBT message length of four minutes, the average power loss is 0.002 dB over five (5) messages. Assuming only one out of every two hundred SBD data messages from the second modem (24) will collide with an LBT message from the first modem (22) and the power loss during this signal collision will be approximately 3.9 dB, this represents an average power loss of approximately 0.01 dB.

In general, given the assumption of infrequent collisions between voice messages and short, frequent data messages, the mixer module (100) can have negligible effects on both LBT messages from the first modem (22) and SBD messages from the second modem (24), other than a very short, shallow reduction in the power signal.

The components may be described in the general context of printed circuit-board design and logic. The processing unit that executes commands and instructions may be a general purpose computer, but may utilize any of a wide variety of other technologies including a special purpose computer, a microcomputer, mini-computer, programmed micro-processor, micro-controller, peripheral integrated circuit element, a CSIC (Customer Specific Integrated Circuit), ASIC (Application Specific Integrated Circuit), a logic circuit, a digital signal processor, a programmable logic device such as an FPGA (Field Programmable Gate Array), PLD (Programmable Logic Device), PLA (Programmable Logic Array), RFID processor, smart chip, or any other device or arrangement of devices that is capable of implementing the logic of the processes of the invention.

Although many other internal components of the system are not shown, those of ordinary skill in the art will appreciate that such components and the interconnections are well known. Accordingly, additional details concerning the internal construction of the system need not be disclosed in connection with the present invention.

The previous description of the disclosed embodiments is provided to enable any person skilled in the art to make or use the present invention. Various modifications to those embodiments will be readily apparent to those skilled in the art, and the generic principles defined herein may be applied to other embodiments without departing from the spirit or scope of the invention. Thus, the present invention is not intended to be limited to the embodiments shown herein, but is to be accorded the full scope consistent with the claims, wherein reference to an element in the singular, such as by use of the article “a” or “an” is not intended to mean “one and only one” unless specifically so stated, but rather “one or more”. All structural and functional equivalents to the elements of the various embodiments described throughout the disclosure that are known or later come to be known to those of ordinary skill in the art are intended to be encompassed by the elements of the claims. Moreover, nothing disclosed herein is intended to be dedicated to the public regardless of whether such disclosure is explicitly recited in the claims.

What is claimed is:

1. A transceiver system comprising a single antenna, said system comprising:
(a) at least two modems comprising a first modem connected to a first communication system, and a second modem connected to a second communication system;
(b) a first transmission path operatively connected to the first modem and comprising a first switch, a second transmission path operatively connected to the second modem and comprising a second switch, a third transmission path operatively connected to both the first and second modems and comprising a signal combiner;
(c) a third switch operatively connected to the single antenna, and operative to select the first, second or third transmission paths, or an incoming signal path;
(d) a first transmission detector connected to the first transmission path, and a second transmission detector connected to the second transmission path;
(e) a controller responsive to the first and second transmission detectors and operatively connected to the first, second and third switches.

2. The system of claim 1 further comprising a first amplifier associated with the first modem and the first and third transmission paths, and a second amplifier associated with the second modem and the second and third transmission paths, wherein both the first and second amplifiers are upstream from the signal combiner.

3. The system of claim 1 wherein the first and second signal paths each comprises a subswitch, which is connected to an amplified signal path in each case, and which is connected to the third signal path and the signal combiner.

4. The system of claim 3 wherein the controller is operative to operate each of the first and second subswitches to utilize the amplified signal path and the third transmission path when the first and second transmission paths are being used at the same time.

5. The system of claim 1 wherein one or both of the first communication system and the second communication system utilize time-division multiplexing.

6. The system of claim 5 wherein one or both the first communication system and the second communication system utilize TDMA multiplexing.

7. The system of claim 5 wherein the first and second communication systems are different, and one of the first and second communication sytems comprises a system configured to send and receive relatively large amounts of data, and the other communication system comprises a system configured to send and receive relatively smaller amounts of data more frequently.

8. A method of utilizing multiple modems with a single antenna, said method comprising:
(a) operating a first modem connected to a first communication system, and a second modem connected to a second communication system;
(b) providing a first transmission path operatively connected to the first modem and comprising a first switch, a second transmission path operatively connected to the second modem and comprising a second switch, a third transmission path operatively connected to both the first and second modems and comprising a signal combiner;
(c) providing a third switch operatively connected to the single antenna, and operative to select the first, second or third transmission paths, or an incoming signal path;
(d) providing a first transmission detector connected to the first transmission path, and a second transmission detector connected to the second transmission path;
(e) controlling the first, second and third switches to route signals from the first modem through the first transmission path when the second modem is not transmitting, or to route signals from the second modem through the second transmission path when the first modem is not transmitting, or to route simultaneous signals from the first and second modems through the third transmission path.

9. The method of claim 8 comprising the further step of separately amplifying the signals from the first and second modems along the third transmission path, prior to combining the signals.

10. The method of claim 8 or 9 wherein one or both of the first modem and the second modem are connected to a communication system using time-division multiplexing.

11. The method of claim 10 wherein the communication system uses TDMA.

12. The method of claim 8 wherein the first communication system and the second communication system are different, and one is configured to handle larger amounts of data more infrequently, and the other is configured to handle smaller amounts of data more frequently.
